(19) United States
(12) Patent Application Publication
(10) Pub. No.: US 2012/0151127 A1
(43) Pub. Date: Jun. 14, 2012

(54) METHOD OF STORING DATA IN A STORING DEVICE INCLUDING A VOLATILE MEMORY DEVICE

(76) Inventor: Sun-Young Lim, Seoul (KR)

(21) Appl. No.: 13/315,822

(22) Filed: Dec. 9, 2011

(30) Foreign Application Priority Data
Dec. 14, 2010 (KR) 10-2010-0127424

(51) Int. Cl. G06F 12/10; G06F 12/00

(52) U.S. Cl. 711/103; 711/206; 711/E12.058

(57) ABSTRACT

In a method of storing data in a storage device including a volatile memory device according to example embodiments, a swap address table containing address information about swap data are generated. The data are received from a host. Whether the received data are the swap data are determined based on the address information stored in the swap address table. The received data are selectively stored in the volatile memory device or in the nonvolatile memory device according to a result of the determination.

### CROSS-REFERENCE TO RELATED APPLICATIONS

This U.S. non-provisional application claims the benefit of priority under 35 U.S.C. §119 to Korean Patent Application No. 2010-0127424 filed on Dec. 14, 2010 in the Korean Intellectual Property Office (KIPO), the entire content of which is incorporated herein by reference in its entirety.

### BACKGROUND

1. Technical Field

Example embodiments relate to storage devices. More particularly, example embodiments relate to methods of storing data in storage devices including volatile memory devices.

2. Description of the Related Art

When loading a new page in a typical computing system, a swap operation may be performed if an unused region of a main memory is not enough to load the new page. The swap operation may store a loaded page from the main memory to a storage device to obtain storage space of the main memory for the new page. Since the speed of a write/read operation of the storage device may be lower than the speed of a write/read operation of the main memory, the operating speed of the computing system may be lowered and the performance of the computing system may be deteriorated due to the swap operation.

### SUMMARY

Some example embodiments provide a method of storing data in a storage device including a volatile memory device capable of improving the performance of a system.

According to example embodiments, in a method of storing data in a storage device including a volatile memory device and a nonvolatile memory device, a swap address table containing address information about swap data is generated. The data are received from a host. Whether the received data are the swap data is determined based on the address information stored in the swap address table. The received data are selectively stored in the volatile memory device or in the nonvolatile memory device according to a result of the determination.

In some embodiments, to generate the swap address table, an address of a swap partition may be read from a partition table stored in the nonvolatile memory device, and the swap address table may be generated based on the read address of the swap partition.

In some embodiments, to generate the swap address table, an address of a swap file stored in the nonvolatile memory device may be read, and the swap address table may be generated based on the read address of the swap file.

In some embodiments, to read the address of the swap file, a start address of the swap file may be read from a directory table stored in the nonvolatile memory device, and addresses linked to the start address of the swap file may be read from a file allocation table stored in the nonvolatile memory device.

In some embodiments, to determine whether the received data are the swap data, whether an address of the received data exists in the swap address table may be determined.

In some embodiments, to determine whether the received data are the swap data, a logical address of the received data may be translated into a physical address, and whether the physical address exists in the swap address table may be determined.

In some embodiments, to selectively store the received data in the volatile memory device or in the nonvolatile memory device, the received data may be stored in the nonvolatile memory device if the received data are not the swap data, and the received data may be stored in the volatile memory device if the received data are the swap data.

In some embodiments, to store the received data in the nonvolatile memory device, the received data may be stored using the volatile memory device as a buffer memory.

In some embodiments, a read request for the swap data may be received from the host, and the swap data stored in the volatile memory device may be provided to the host in response to the read request.

In some embodiments, a delayed write operation that writes the swap data stored in the volatile memory device to the nonvolatile memory device may be performed while the storage device performs neither a write operation nor a read operation.

In some embodiments, a read request for the swap data may be received from the host, the swap data stored in the volatile memory device may be provided to the host in response to the read request, and the swap data that are stored in the nonvolatile memory device by the delayed write operation may be erased.

In some embodiments, other data to be stored in the volatile memory device may be received, the other data may be written to a region of the volatile memory device where the swap data are stored if an unused region of the volatile memory device is not enough to store the other data, thereby overwriting the swap data, a read request for the swap data may be received from the host, and the swap data that are stored in the nonvolatile memory device by the delayed write operation may be provided to the host in response to the read request.

According to example embodiments, in a method of storing data in a storage device including a volatile memory device and a nonvolatile memory device, data and a information indicating whether the data is swap data or non-swap data are received from a host. Whether the received data are swap data is determined based on the information. The received data are selectively stored in the volatile memory device or in the nonvolatile memory device according to a result of the determination.

In some embodiments, the information may be an address sent with the swap data, or a swap flag.

In some embodiments, the swap flag may be included in a write command received from the host.

In some embodiments, the swap flag may be appended to the received data.

In another embodiment, a storage device includes a volatile memory, a nonvolatile memory, and a controller. The controller is configured to receive data from a host, the data being either swap data or non-swap data; determine whether the data is swap data or non-swap data; store the data in the volatile memory if the data is determined to be swap data; and store the data in the nonvolatile memory if the data is determined to be non-swap data.

In some embodiments the controller is further configured to perform a delayed write operation that writes swap data stored in the volatile memory to the nonvolatile memory during idle time; overwrite the swap data stored in the volatile memory with second swap data received from the host; and supply the swap data stored in the nonvolatile memory back to the host in response to a read request.

In some embodiments, the controller is further configured to determine whether the data is swap data or non-swap data based on either an address associated with the data or a swap flag associated with the data, such that if an address associated with the data is determined to be an address for swap data or if the swap flag indicates that the data is swap data, the data is stored in the volatile memory.

As described above, a method of storing data in a storage device including a volatile memory device according to example embodiments may improve the speed of a swap operation and the performance of a system.

### BRIEF DESCRIPTION OF THE DRAWINGS

Illustrative, non-limiting example embodiments will be more clearly understood from the following detailed description taken in conjunction with the accompanying drawings.

FIG. 1 is a block diagram illustrating a computing system including a storage device according to example embodiments.

FIGS. 2A and 2B are diagrams for describing examples where a swap operation needs to be performed in a computing system, according to example embodiments.

FIG. 3 is a flow chart illustrating a method of storing data in a storage device including a volatile memory device according to example embodiments.

FIG. 4 is a block diagram for describing an example of an operation that stores swap data in a storage device illustrated in FIG. 1, according to example embodiments.

FIGS. 5A and 5B are block diagrams illustrating examples of an operation that outputs swap data from a storage device illustrated in FIG. 1, according to example embodiments.

FIG. 6 is a block diagram illustrating a storage device according to example embodiments.

FIG. 7 is a diagram illustrating an example of a nonvolatile memory device illustrated in FIG. 6, according to example embodiments.

FIG. 8 is a flow chart illustrating a method of storing data in a storage device including a volatile memory device according to example embodiments.

FIG. 9 is a flow chart illustrating a method of outputting swap data from a storage device including a volatile memory device according to example embodiments.

FIG. 10 is a block diagram illustrating a storage device according to example embodiments.

FIG. 11 is a diagram illustrating an example of a nonvolatile memory device illustrated in FIG. 10, according to example embodiments.

FIG. 12 is a flow chart illustrating a method of storing data in a storage device including a volatile memory device according to example embodiments.

FIG. 13 is a block diagram illustrating a storage device according to example embodiments.

FIG. 14 is a diagram illustrating an example of data to which a swap flag is appended, according to example embodiments.

FIGS. 15A and 15B are diagrams illustrating examples of a command including a swap flag, according to example embodiments.

FIG. 16 is a flow chart illustrating a method of storing data in a storage device including a volatile memory device according to example embodiments.

FIG. 17 is a diagram illustrating a memory card including a storage device according to example embodiments.

FIG. 18 is a diagram illustrating an embedded multimedia card including a storage device according to example embodiments.

FIG. 19 is a diagram illustrating a solid state drive including a storage device according to example embodiments.

FIG. 20 is a diagram illustrating a mobile system including a storage device according to example embodiments.

### DETAILED DESCRIPTION OF THE EMBODIMENTS

Various example embodiments will be described more fully hereinafter with reference to the accompanying drawings, in which some example embodiments are shown. The present inventive concept may, however, be embodied in many different forms and should not be construed as limited to the example embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

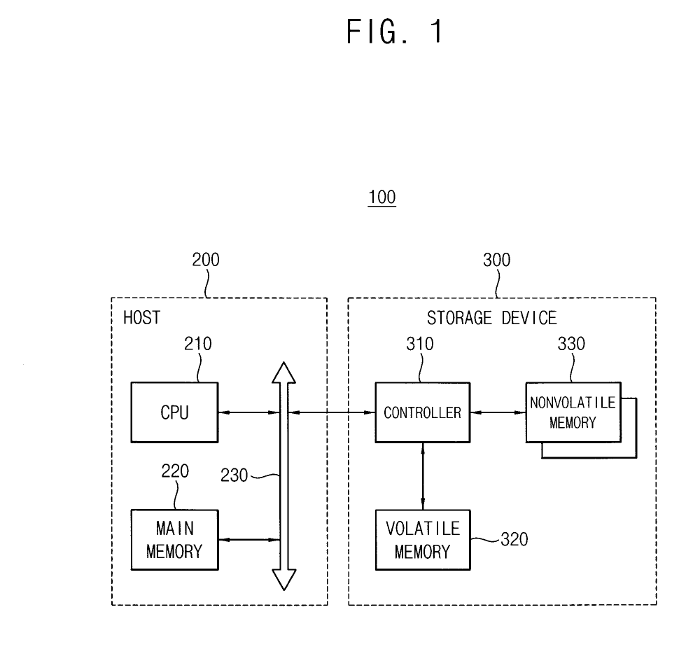

FIG. 1 is a block diagram illustrating a computing system including a storage device according to example embodiments.

Referring to FIG. 1, an exemplary computing system 100 includes a host 200 and a storage device 300.

In one embodiment, the host 200 includes a processor 210, a main memory 210 and a bus 230, and may be, for example, a computer that includes an operating system (OS). The processor 210 performs various computing functions, such as executing specific software for performing specific calculations or tasks. For example, the processor 210 may be a microprocessor, a central process unit (CPU), a digital signal processor, or the like, that includes integrated circuitry and other electronic elements for performing processing.

In one embodiment, the processor 210 is coupled to the main memory 220 via a bus 230, such as an address bus, a control bus and/or a data bus. For example, the main memory 220 may be implemented by a dynamic random access memory (DRAM). In other examples, the main memory 220 may be implemented by a static random access memory (SRAM), a flash memory, a mobile DRAM, a phase random access memory (PRAM), a ferroelectric random access memory (FRAM), a resistive random access memory (RRAM), a magnetic random access memory (MRAM), etc.

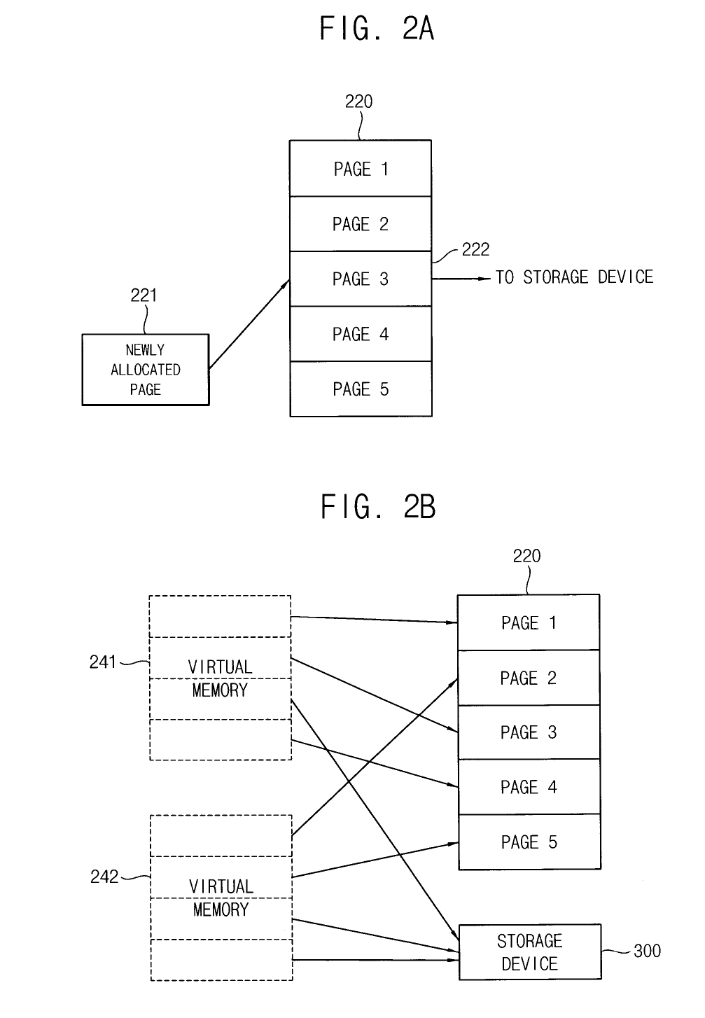

When loading a new page into the main memory 220, the processor 210 may perform a swap operation if an unused region of the main memory 220 is not enough to store the new page. The swap operation may store at least one of a set of loaded pages from the main memory 220 to the storage device 300 to obtain storage space for the new page. Examples where the swap operation needs to be performed will be described in detail below with reference to FIGS. 2A and 2B.

In one embodiment, the storage device 300 includes a controller 310, a volatile memory device 320, and at least one nonvolatile memory device 330. The volatile memory device 320 and nonvolatile memory device 330 may each include, for example, one or more semiconductor memory chips that include one or more arrays of memory cells. The controller may include, for example, circuitry and other electronic elements configured to perform control functions. The controller 310 may receive commands from the host 200, and controls an operation of the storage device 300 in response to the commands The storage device 300 may be, for example, a multimedia card, hard disk drive (HDD), or solid state drive (SSD), as described further below.

The volatile memory device 320 may store an address translation table to translate a logical address received from the host 200 into a physical address of the nonvolatile memory device 330. In some embodiments, the volatile memory device 320 may serve as a write buffer temporarily storing data provided from the host 200 and/or as a read cache temporarily storing data output from the nonvolatile memory device 330. For example, the volatile memory device 320 may be implemented by a DRAM or a SRAM. Although FIG. 1 illustrates an example where the volatile memory device 320 is located outside the controller 310, in some embodiments, the volatile memory device 320 may located inside the controller 310 (e.g., the volatile memory device 320 and controller 310 may be included in different chips or packages or in a same chip or package).

The nonvolatile memory device 330 may store data provided from the host 200. The nonvolatile memory device 330 may retain stored data even if the nonvolatile memory device 330 is not supplied with power. For example, the nonvolatile memory device 330 may be implemented by a NAND flash memory, a NOR flash memory, a PRAM, a FRAM, a RRAM, a MRAM, etc.

The controller 310 may receive data from the host 200, and may determine whether the received data are normal data (e.g., data originally intended for storage in the storage device 300) or swap data (e.g., data originally stored at the host 200, but later sent to the storage device 300 to free space for new data to be stored at the host 200). The controller 310 may selectively store the received data in the volatile memory device 320 or in the nonvolatile memory device 330 according to a result of the determination. For example, the controller 310 may store the received data in the nonvolatile memory device 330 if the received data are the normal, non-swap data (i.e., data not received as part of a swap out operation), and may store the received data in the volatile memory device 320 if the received data are the swap data. Accordingly, since the swap data are stored not in the nonvolatile memory device 330 but in the volatile memory device 320, a period of time it takes for the swap data to be written to the storage device 300 may decrease, thereby reducing a period of time during which the host 200 waits for a response to a write request for the swap data. Further, the storage device 300 and/or the host 200 may perform another operation immediately after the swap data are stored in the volatile memory device 320. Accordingly, the performance of the computing system 100 may be improved.

In some embodiments, the controller 310 may perform a delayed write operation that writes the swap data stored in the volatile memory device 320 to the nonvolatile memory device 330 while there are no or few requests from the host 200. For example, while the storage device 300 performs neither a write operation nor a read operation, the controller 310 may perform the delayed write operation. In other examples, while the storage device 300 is in a stand-by state, a sleep state, a disconnect state, etc., the controller 310 may perform the delayed write operation. These examples are collectively described herein as “idle states,” during which the storage device 300 may perform the delayed write operation.

The controller 310 may receive a read request for the swap data from the host 200. The controller 310 may provide the swap data stored in the volatile memory device 320 to the host 200 in response to the read request. Accordingly, a period of time it takes for the swap data to be output from the storage device 300 may decrease, thereby reducing a period of time during which the host 200 waits for a response to the read request for the swap data.

In a case where the swap data have been erased from the volatile memory device 320, the controller 310 may provide the swap data that are stored in the nonvolatile memory device 330 by the delayed write operation to the host 200 in response to the read request. For example, if the controller 310 receives second swap data from the host 200 when first swap data is already stored in the volatile memory device 320, and an unused region of the volatile memory device 320 is not enough to store the second swap data, the controller 310 may write the second swap data to a region where the first swap data are stored. Accordingly, the first swap data may be overwritten and thereby removed from the volatile memory device 320. In this case, the controller 310 would have performed the delayed write operation before the first swap data were erased from the volatile memory device 320, and can then later provide the first swap data that are stored in the nonvolatile memory device 330 by the delayed write operation to the host 200 in response to the read request.

As described above, since the host 200 and/or the storage device 300 may perform another operation immediately after the swap data are written to the volatile memory device 320, the performance of the computing system 100 according to example embodiments may be improved.

FIGS. 2A and 2B are diagrams for describing examples where a swap operation is performed in a computing system, according to certain exemplary embodiments.

Referring to FIG. 2A, a main memory 220 may be divided into a plurality of segments or a plurality of pages into which data may be stored. These include, for example, memory cells, and may be referred to herein as physical pages. For example, each page of the main memory 220 may have a size equal or greater than about 4 KB.

In a case where a new page 221 of data, which may be referred to herein as a data page, should be allocated in the main memory 220, but no unused physical page in the main memory 220 exists, a swap-out operation may be performed. The swap-out operation may write at least one data page 222 (e.g., stored in a physical page of main memory 220) to a storage device, such as storage device 300, as swap data. For example, the data page 222 to be written to the storage device may include the data stored at a least recently used physical page of the main memory 220. Later, if the data page 222 stored in the storage device 300 needs to be accessed, another data page may be stored in the storage device by the swap-out operation, and the data page 222 may be again stored in the main memory 220 by a swap-in operation.

In a computing system according to example embodiments, when the page 222 is stored in the storage device 300 by the swap-out operation, the page 222 may be stored not in a nonvolatile memory device but in a volatile memory device. Accordingly, the performance of the computing system may be improved.

Referring to FIG. 2B, a computing system may employ a memory management technique that supports a virtual memory scheme. The computing system may allocate virtual memories 241 and 242 to executed processes, respectively. For example, a first virtual memory 241 may be allocated to a first process, and a second virtual memory 242 may be allocated to a second process. Further, when a new process is executed, a new virtual memory may be allocated to the new process.

When the virtual memories 241 and 242 are accessed, the processes may indicate a location of data using a virtual address that is an address for the virtual memories 241 and 242.

The virtual address may be translated into a physical address (or, a real address) that is an address for the main memory 220 (or of memory in storage device 300) so that a processor may access the data. For example, when the processor fetches or processes an instruction or data, the virtual address may be translated into the physical address.

This translation from the virtual address to the physical address may be performed by a memory management unit (MMU). The MMU may be included in the processor, or may be implemented as a separate device.

The MMU may perform the translation using a page table containing mapping information between the virtual address and the physical address. For data stored in storage device 300, the page table may include mapping information between the virtual address and a physical address of memory in the storage device 300. In some embodiments, the MMU may include a translation lookaside buffer (TLB) that is a cache storing recently used mapping information.

To perform the translation, the MMU may first search the TLB. If the mapping information for a virtual address to be translated does not exist in the TLB, the MMU may search the page table. In a case where a page corresponding to the virtual address to be translated is loaded in the main memory 220, the MMU may translate the virtual address into the physical address for the main memory 220 based on the mapping memory stored in the TLB or the page table.

In a case where a page corresponding to the virtual address to be translated is stored in a storage device, the MMU may perform a swap-in operation to load the page from the storage device to the main memory 220. After the page is loaded in the main memory 220, the MMU may output the physical address corresponding to the page loaded in the main memory 220, and may update the TLB and/or the page table.

In a case where a new page should be loaded in the main memory 220 in which no unused page exists, a swap-out operation may be performed to obtain storage space for the new page. For example, if the first process is activated, a page of the first virtual memory 241 may be loaded from the storage device to the main memory 220. In other examples, if a new process is executed, a virtual memory may be newly allocated to the new process, and a page of the newly allocated virtual memory may be loaded in the main memory 220. In these cases, if an unused page of the main memory 220 does not exist, at least one page loaded in the main memory 220 should be swapped out. For example, a least recently used page may be swapped out.

In a computing system according to example embodiments, when a page is stored in the storage device 300 by the swap-out operation, the page may be stored not in a nonvolatile memory device but in a volatile memory device. Accordingly, the performance of the computing system may be improved.

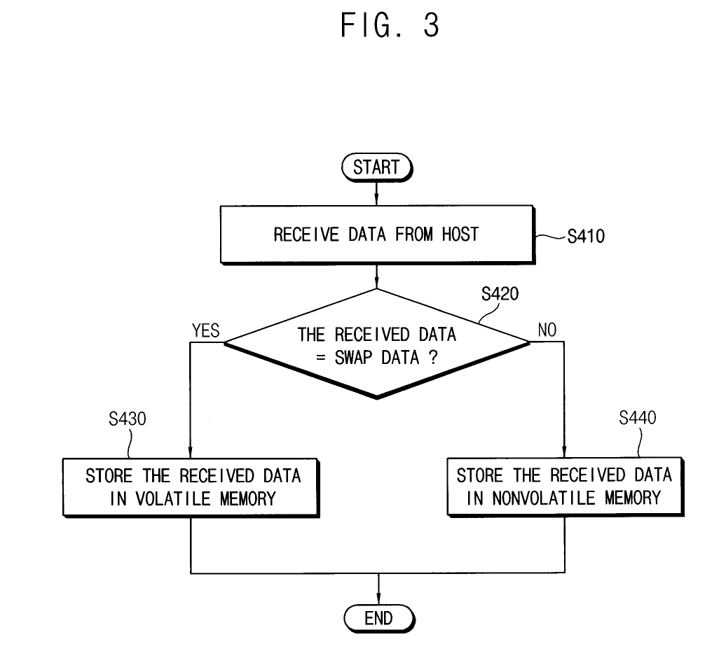

FIG. 3 is a flow chart illustrating a method of storing data in a storage device including a volatile memory device according to example embodiments.

Referring to FIGS. 1 and 3, a storage device 300 may receive data from a host 200 (S410). The received data may be, for example, normal data to be stored in a nonvolatile memory device 330 or swap data provided from a main memory 220 to obtain storage space of the main memory 220. The storage device 300 may determine whether the received data are the swap data (S420).

If the received data are the normal data (S420: NO), the storage device 300 may store the received data in the nonvolatile memory device 330 (S440). In some embodiments, the storage device 300 may store the received data using a volatile memory device 320 as a buffer memory.

If the received data are the swap data (S420: YES), the storage device 300 may store the received data in the volatile memory device 320 (S430). Because the data is stored in volatile memory device 320 when the swap data are written to the storage device 300, the host 200 does not need to wait for the data to be written to the nonvolatile memory device 330, and may perform a subsequent operation immediately after the swap data are written to the volatile memory device 320. Further, the storage device 300 may also perform an operation in response to another request from the host 200 immediately after the swap data are written to the volatile memory device 320. Accordingly, a method of storing data in the storage device 300 including the volatile memory device 320 according to example embodiments may rapidly perform a swap operation, thereby improving the performance of the computing system 100.

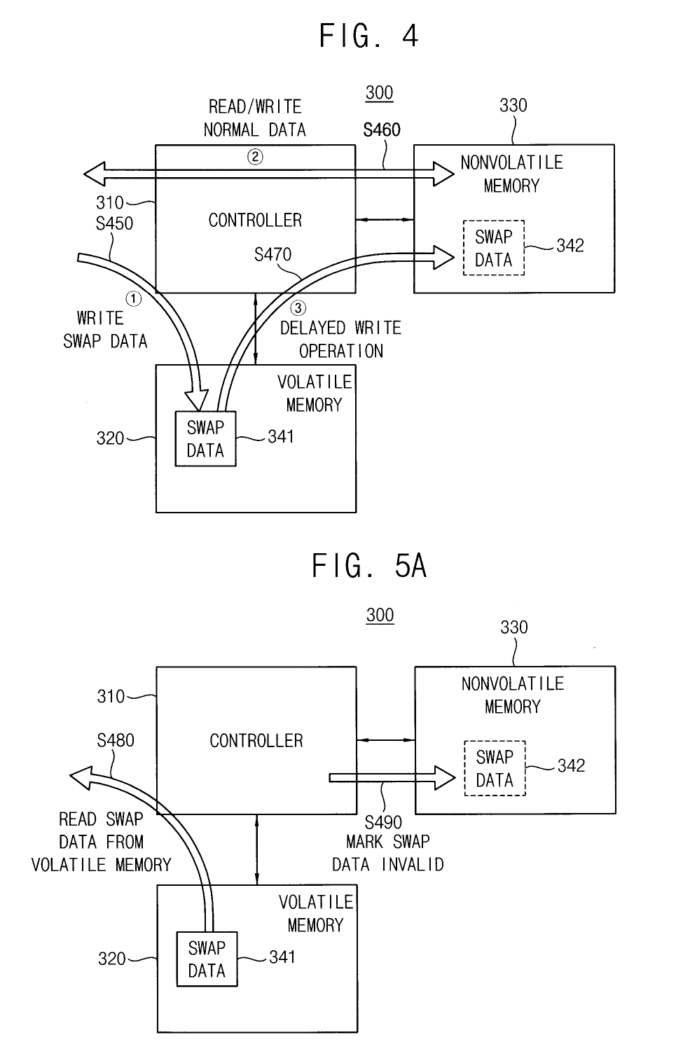

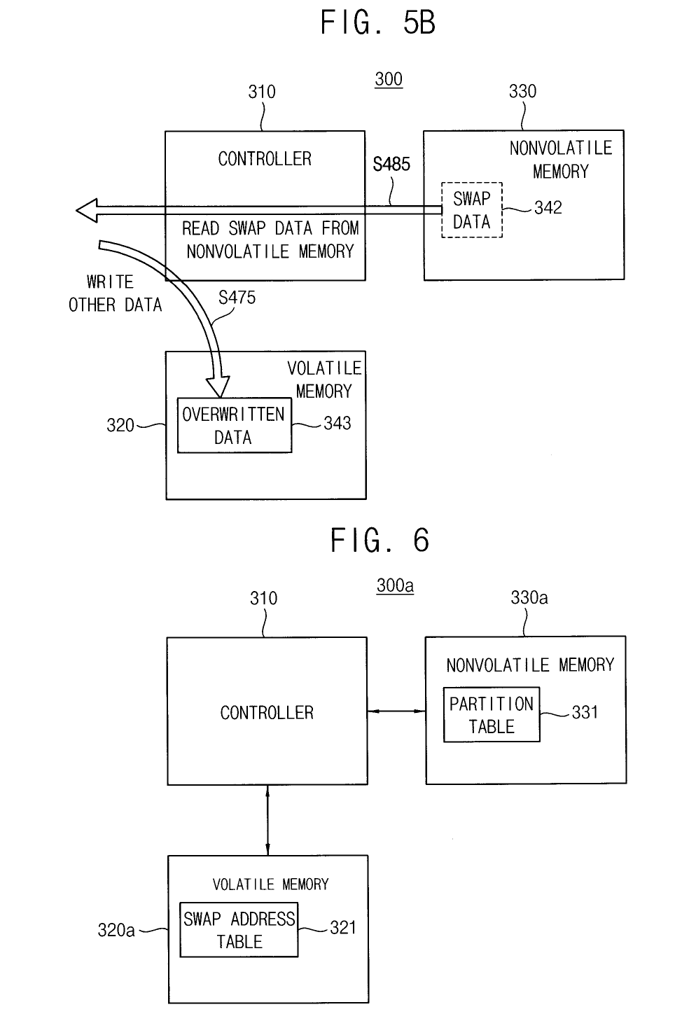

FIG. 4 is a block diagram for describing an example of an operation that stores swap data in a storage device illustrated in FIG. 1, according to one embodiment, and FIGS. 5A and 5B are block diagrams illustrating examples of an operation that outputs swap data from a storage device illustrated in FIG. 1.

Referring to FIG. 4, swap data 341 provided from a host may be written to a volatile memory device 320 (S450). Thereafter, if a storage device 300 receives a read request or a write request for normal data from the host, the storage device 300 may perform an operation according to the read request or the write request (S460). That is, a computing system including the storage device 300 may perform another operation immediately after performing a swap operation.

In some embodiments, a controller 310 may perform a delayed write operation that writes the swap data 342 to the nonvolatile memory device 342 while there are no or few requests from the host 200 (S470). For example, while the storage device 300 performs neither the write operation nor the read operation, or while the storage device 300 is in a stand-by state, a sleep state, a disconnect state, or during other idle time, the controller 310 may perform the delayed write operation.

As described above, in a computing system including the storage device 310, since the swap data 341 are written to the volatile memory device 320, and the swap data 342 are later written to the nonvolatile memory device 330 when there are no or few requests, the swap operation may be rapidly performed, and the performance of the computing system may be improved.

Referring to FIG. 5A, if the storage device 300 receives a read request for the swap data from the host, the storage device 300 may provide the swap data 341 stored in the volatile memory device 320 to the host (S480). In some embodiments, if a delayed write has been performed, after the storage device 300 provides the swap data 341 to the host, the controller 310 may mark the swap data 342 stored in the nonvolatile memory device 330 invalid (S490). The swap data 342 marked invalid may be immediately erased, or may be later erased when there are no or few requests. Accordingly, an overhead for unnecessary data may be reduced.

In other embodiments, although the swap data 341 stored in the volatile memory device 320 are provided to the host by the swap-in operation, the swap data 342 stored in the nonvolatile memory device 330 may be retained. In this case, if the swap data 341 loaded in a main memory by the swap-in operation are later requested to be swapped out without being modified, the computing system may not perform a swap-out operation for the swap data 341 since the swap data 342 exist in the nonvolatile memory device 330. When the swap-in operation for the swap data are again performed, the storage device 300 may provide the swap data 342 stored in the nonvolatile memory device 330 to the host. Accordingly, the performance of the computing system may be further improved.

Referring to FIG. 5B, before the storage device 300 receives a read request for first stored swap data, the storage device 300 may receive a write request for second swap data 343. In a case where an unused region of the volatile memory device 320 is not enough to store the second swap data, the second swap data 343 may be overwritten to a region where the first swap data are stored (S475). Accordingly, the first swap data may be removed from the volatile memory device 320 but may be remain on the non-volatile device 330.

If the first swap data are removed from the volatile memory device 320, the storage device 300 may provide the first swap data 342 stored in the nonvolatile memory device 330 to the host in response to the read request for the first swap data (S485).

FIG. 6 is a block diagram illustrating a storage device according to example embodiments.

Referring to FIG. 6, a storage device 300a includes a controller 310, a volatile memory device 320a and a nonvolatile memory device 330a, according to one exemplary embodiment.

The nonvolatile memory device 330a may be divided into a data partition and a swap partition, and may include a partition table 331 containing information about the partitions. For example, in one embodiment, when the storage device 300 is initially formatted by the host 200, the host 200 may allocate a first portion of the nonvolatile memory device 330a for swap data and a second portion of the nonvolatile memory device 330a for normal data. At such time, the host 200 may keep its own page table that describes, for example, which logical addresses of the nonvolatile memory device 330a are for swap data and which are for normal data.

The controller 310 may read an address of the swap partition from the partition table 331, and may generate a swap address table 321 containing address information about swap data based on the address of the swap partition. According to certain embodiments, the swap address table 321 may be stored in the volatile memory device 320a, or may be stored in another memory included in the controller 310. Further, according to certain embodiments, the swap address table 321 may contain a logical address or a physical address for the swap data.

If the controller 310 receives data from a host, the controller 310 may determine whether the received data are swap data based on the address information stored in the swap address table 321. For example, in one embodiment, if an address of the received data (e.g., an address received with the data from the host) exists in the swap address table 321 (e.g., the address provided from the host was for one of the pages designated as swap data pages), the controller 310 decides that the received data are the swap data, and if the address of the received data does not exist in the swap address table 321, the controller 310 decides that the received data are not the swap data.

In some embodiments, the physical address for the swap data may be stored in the swap address table 321, and the controller 310 may determine whether a physical address for the received data exists in the swap address table 321 after the controller 310 translates a logical address of the received data into the physical address. In other embodiments, the logical address for the swap data may be stored in the swap address table 321, and the controller 310 may determine whether the logical address for the received data exists in the swap address table 321.

The controller 310 may selectively store the received data in the volatile memory device 320a or in the nonvolatile memory device 330a according to a result of the determination. For example, the controller 310 may store the received data in the nonvolatile memory device 330a if the received data are normal data, and may store the received data in the volatile memory device 320a if the received data are swap data. Accordingly, a swap operation may be rapidly performed.

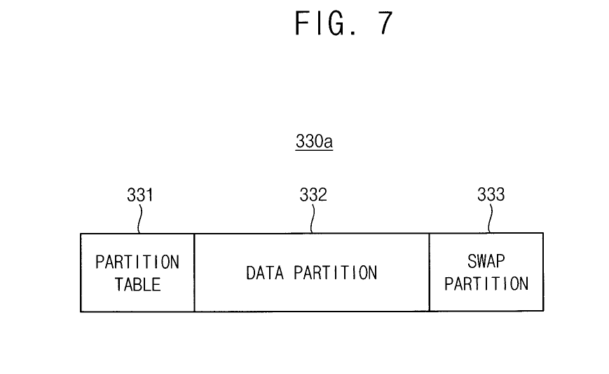

FIG. 7 is a diagram illustrating an example of a nonvolatile memory device illustrated in FIG. 6, according to one exemplary embodiment.

Referring to FIG. 7, a nonvolatile memory device 330a may include a partition table 331, a data partition 332 and a swap partition 333. Normal data may be stored in the data partition 332, and swap data may be stored in the swap partition 333. Information about the data partition 332 and the swap partition 333 may be stored in the partition table 331. For example, the partition table 331 may contain a start address, a size, etc. of the data partition 332 and the swap partition 333. A controller 310 illustrated in FIG. 6 may generate a swap address table containing address information about the swap data based on the information stored in the partition table 331.

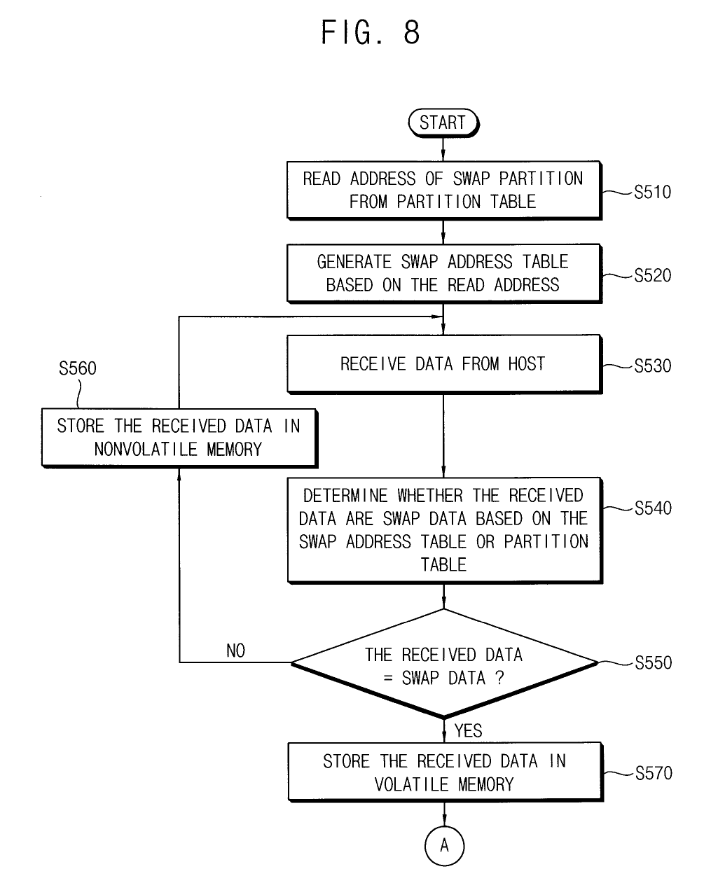

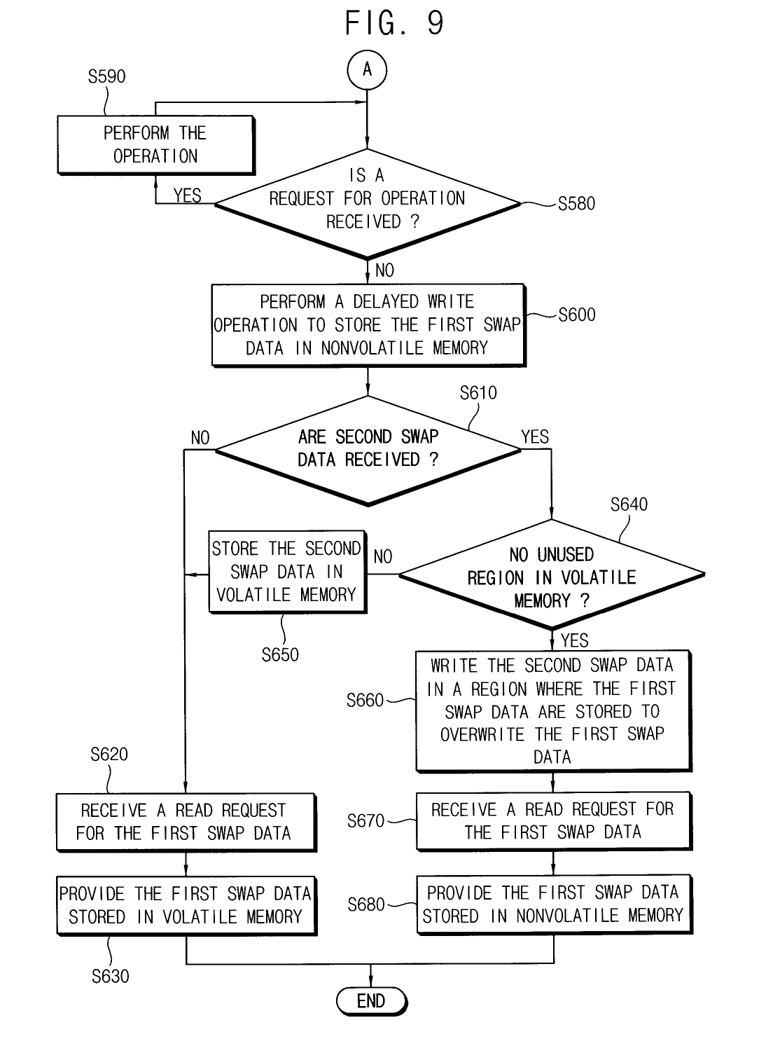

FIG. 8 is a flow chart illustrating a method of storing data in a storage device including a volatile memory device according to example embodiments, and FIG. 9 is a flow chart illustrating a method of outputting swap data from a storage device including a volatile memory device according to example embodiments.

Referring to FIGS. 6 through 9, a controller 310 may read an address for a swap partition 333 from a partition table 331 stored in a nonvolatile memory device 330a (S510). The controller 310 may generate a swap address table 321 containing address information about swap data based on the read address (S520). The addresses for the swap partition 333 for the nonvolatile memory device 330a may be set according to formatting or configuration instructions received from a host, such as host 200 discussed previously. As such, the host may also keep a table that indicates which addresses of the nonvolatile memory device 330a are for swap data and which are for normal data.

If the controller 310 receives data from a host (S530), including an address, the controller 310 may determine whether the received data are the swap data based on the received address and either the swap address table 321 or the partition table 331 (S540). For example, in one embodiment, if an address of the received data exists in the swap address table 321, or if the address of the received data is an address for the swap partition 333, the controller 310 decides that the received data are the swap data. For example, the controller 310 may first look up swap address table 321 for an address, and then lookup partition table 331 if the address is not in the swap address table 321, to determine if the data is swap data. If the address of the received data does not exist in the swap address table 321, and if the address of the received data is an address for the data partition 332, the controller 310 may decide that the received data are normal data.

In one embodiment, if the received data are the normal data (S550: NO), the controller 310 stores the received data in the nonvolatile memory device 330a (S560). If the received data are the swap data (S550: YES), the controller 310 stores the received data in a volatile memory device 320a (S570).

If the controller 310 receives a subsequent request for an operation from the host (S580: YES), the storage device 300a may perform the operation according to the request immediately after storing the swap data in the volatile memory device 320a (S590). Accordingly, the performance of a computing system including the storage device 300a may be improved.

If the controller 310 does not receive the request from the host during a predetermined period of time (S580: NO), the controller 310 may perform a delayed write operation that stores the swap data stored in the volatile memory device 320a to the nonvolatile memory device 330a (S600).

The controller 310 may receive a read request for the swap data (S620, S670). If the delayed write operation is not yet performed, or if the controller 310 does not receive second data (e.g., second swap data) that are to be stored in the volatile memory device 320a (S610: NO), the controller 310 may provide the swap data stored in the volatile memory device 320a to the host in response to the read request (S620, S630).

Further, if an unused region of the volatile memory device 320a is enough to store the second data although the controller 310 receives the second data to be stored in the volatile memory device 320a (S610: YES, 5640: NO), the controller 310 may store the second data in the volatile memory device 320a (S650), and may provide the first swap data stored in the volatile memory device 320a to the host in response to the read request (S620, S630).

If an unused region of the volatile memory device 320a is not enough to store the second swap data when the controller 310 receives the second swap data to be stored in the volatile memory device 320a (S610: YES, 5640: YES), the controller 310 may write the second swap data to a region where the first swap data are stored (S660), thereby overwriting the first swap data. Accordingly, the first swap data may be removed from the volatile memory device 320a. In this case, prior to the overwriting, the first swap data may have been stored in a delayed write operation in nonvolatile memory device 330a. Accordingly, the controller 310 may provide the swap data that are stored in the nonvolatile memory device 330a by the delayed write operation to the host in response to the read request (S670, S680).

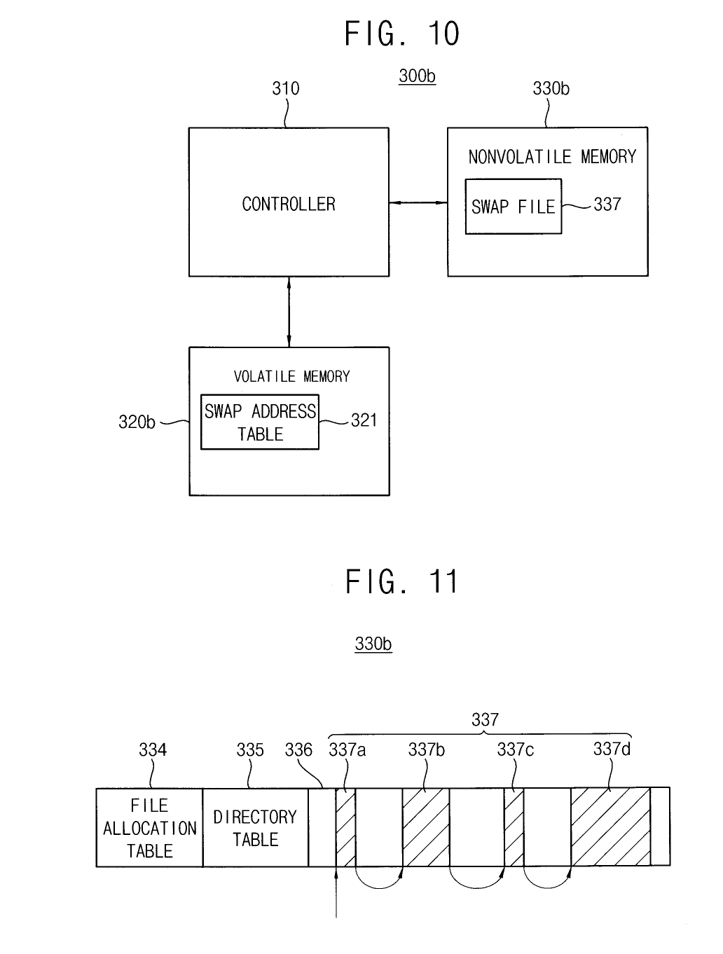

FIG. 10 is a block diagram illustrating a storage device according to example embodiments.

Referring to FIG. 10, a storage device 300b includes a controller 310, a volatile memory device 320b and a nonvolatile memory device 330b.

In one embodiment, the nonvolatile memory device 330b stores a swap file 337 that is a region where swap data are to be written. For example, an operating system of a host device, such as host 200, may format the nonvolatile memory device 330b such that certain address regions are allocated for swap data. Rather than a contiguous partition, the address regions may comprise a set of separated clusters of addresses that together form a swap file, such as swap file 337. Furthermore, the controller 310 may read an address of the swap file 337 stored in the nonvolatile memory device 330b, and may generate a swap address table 321 containing address information about the swap data based on the address of the swap file 337. For example, to read the address of the swap file 337, the controller 310 may read a start address of the swap file 337 from a directory table stored in the nonvolatile memory device 330b, and may read addresses linked to the start address of the swap file 337 from a file allocation table stored in the nonvolatile memory device 330b.

If the controller 310 receives data from a host, the controller 310 may determine whether the received data are the swap data based on the address information stored in the swap address table 321, and an address assigned by the host for the swap data. The controller 310 may selectively store the received data in the volatile memory device 320b or in the nonvolatile memory device 330b according to a result of the determination, in a similar manner of determination as described previously. For example, the controller 310 may store the received data in the volatile memory device 320b if the received data are normal data, and may store the received data in the nonvolatile memory device 330b if the received data are the swap data. Accordingly, a swap operation may be rapidly performed.

FIG. 11 is a diagram illustrating an example of a nonvolatile memory device illustrated in FIG. 10.

Referring to FIG. 11, the nonvolatile memory device 330b may include a file allocation table 334, a directory table 335 and a data region 336. The data region 336 may be divided into a plurality of clusters, and each file stored in the data region 336 may be comprised of one or more scattered clusters that are linked to each other using a linked list. The file allocation table 334 may contain link information for the clusters. The directory table 335 may contain a name, an extension, an attribute, a creation date, a creation time, an address of a start cluster, size, etc. of each file or folder.

A swap file 337 (e.g., a set of separated allocated clusters) where swap data are to be written may be stored in the data region 336. The swap file 337 may include a plurality of clusters 337a, 337b, 337c and 337d, which are scattered and linked to each other using a linked list.

A controller 310 illustrated in FIG. 10 may read a start address of the swap file 337 (i.e., an address of a start cluster 337a of the swap file 337) from the directory table 335. The controller 310 illustrated in FIG. 10 may read addresses linked to the start address of the swap file 337 (i.e., addresses of clusters 337b, 337c and 337d linked to the start cluster 337a) from the file allocation table 334. The controller 310 illustrated in FIG. 10 may generate a swap address table containing address information about the swap file based on the start address and the linked addresses.

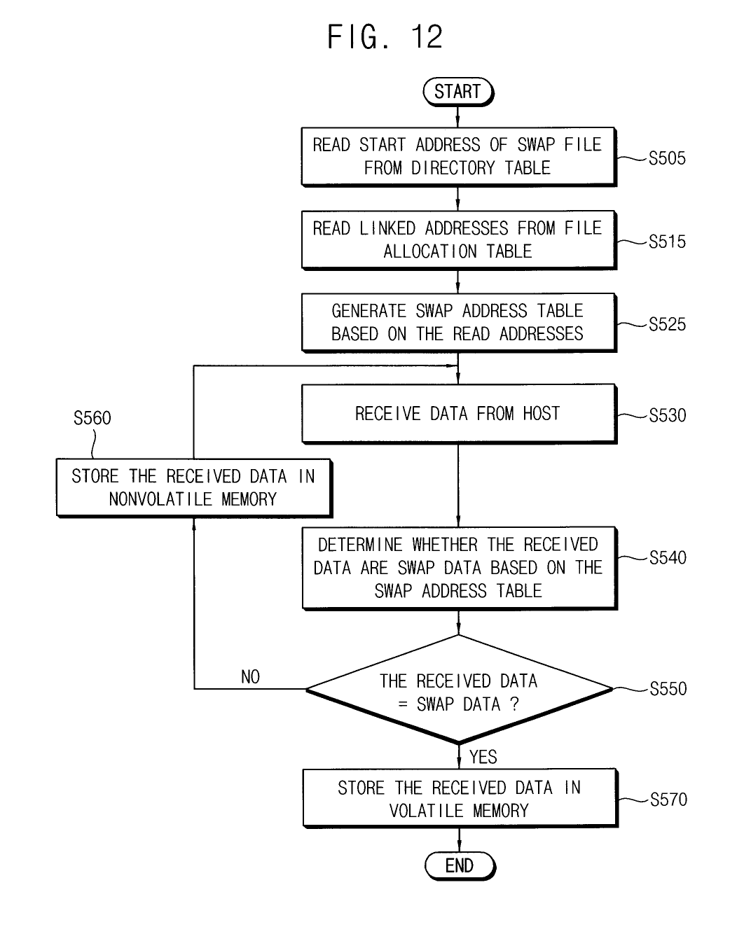

FIG. 12 is a flow chart illustrating a method of storing data in a storage device including a volatile memory device according to example embodiments.

Referring to FIGS. 10, 11 and 12, a controller 310 may read a start address of a swap file 337 from a directory table 335 included in a nonvolatile memory device 330b (S505). The controller 310 may read addresses linked to the start address from a file allocation table 334 included in the nonvolatile memory device 330b (S515). The controller 310 may generate a swap address table 321 containing address information about swap data based on the read addresses (S525).

If the controller 310 receives data from a host (S530), the controller 310 may determine whether the received data are swap data based on the swap address table 321 (S540). For example, in one embodiment, if an address of the received data exists in the swap address table 321, or if the address of the received data is an address for the swap file 337, the controller 310 decides that the received data are the swap data. If the address of the received data does not exist in the swap address table 321, and the address of the received data is not an address for the swap file 337, the controller 310 decides that the received data are normal data.

In one embodiment, if the received data are the normal data (S550: NO), the controller 310 stores the received data in the nonvolatile memory device 330b (S560). If the received data are the swap data (S550: YES), the controller 310 initially stores the received data in the volatile memory device 320b (S570). The swap data stored in the volatile memory device 320b may be written to nonvolatile memory in a delayed write operation, and/or may be output according to the method illustrated in FIG. 9.

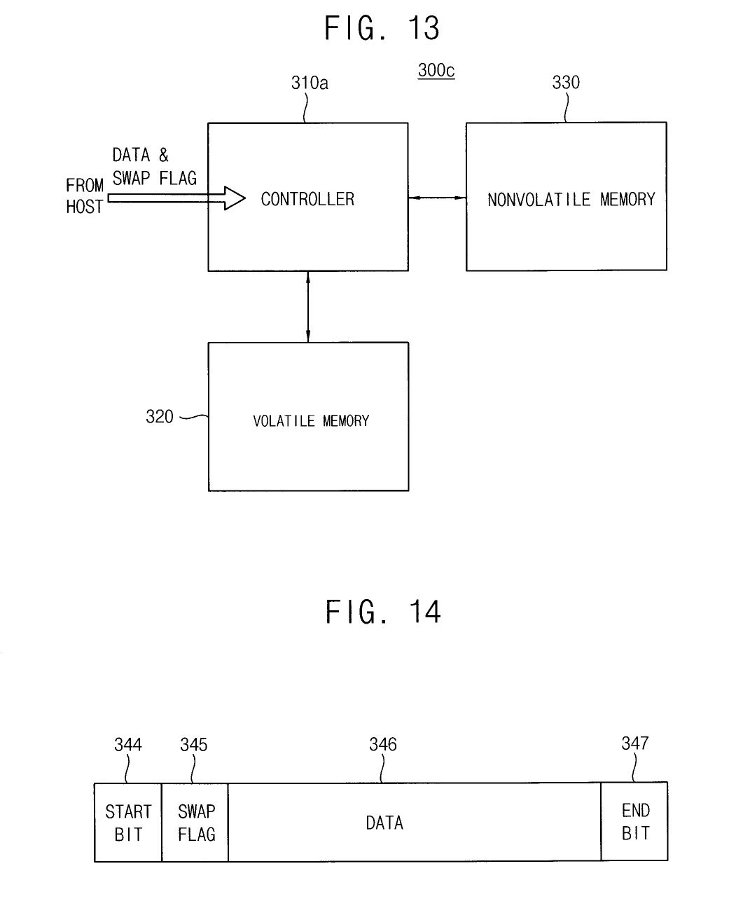

FIG. 13 is a block diagram illustrating a storage device according to alternative example embodiments.

Referring to FIG. 13, a storage device 300c includes a controller 310a, a volatile memory device 320 and a nonvolatile memory device 330.

The controller 310a may receive data and a swap flag indicating whether the received data are swap data from a host. The controller 310a may determine whether the received data are the swap data based on the swap flag. In some embodiments, the swap flag may be included in a write command received from the host, or may be appended to the received data.

The controller 310a may selectively store the received data in the volatile memory device 320 or in the nonvolatile memory device 330 according to a result of the determination. For example, the controller 310a may store the received data in the volatile memory device 320 if the received data are swap data, and may store the received data in the nonvolatile memory device 330 if the received data are not swap data. Accordingly, a swap operation may be rapidly performed.

FIG. 14 is a diagram illustrating an example of data to which a swap flag is appended.

Referring to FIG. 14, when a host transmits data 346, the host may append a start bit 344 before the data 346, and an end bit 347 after the data 347. Further, the host may insert a swap flag 345 indicating whether the data 346 are swap data between the start bit 344 and the data 346 or between the data 346 and the end bit 347. In some embodiments, the swap flag 345 may have a size of one bit. According to embodiments, the data 346 may be transferred in a stream manner or on a block basis, and a cyclic redundancy check (CRC) code may be further appended to the data 346.

A controller 310a illustrated in FIG. 13 may determine whether the data 346 are the swap data based on the swap flag 345 appended to the data 346.

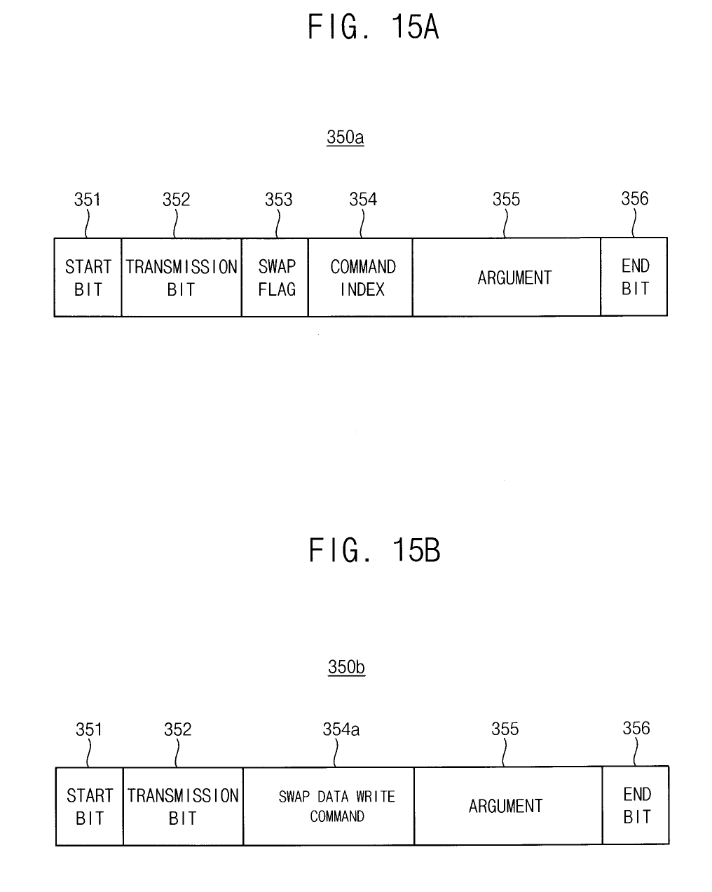

FIGS. 15A and 15B are diagrams illustrating examples of a command including a swap flag.

Referring to FIG. 15A, a command 350a may include a start bit 351, a transmission bit 352, a swap flag 353, a command index 354, an argument 355 and an end bit 356. The start bit 351 may indicate a start of the command 350a. For example, the start bit 351 may be fixed to ‘0’. The transmission bit 352 may indicate a direction in which the command 350a is transmitted. For example, the transmission bit 352 may be ‘1’ in a case where a host transmits the command 350a, and may be ‘0’ in a case where a storage device transmits the command 350a. The swap flag 353 may indicate whether data to be written are swap data. The command index 354 may indicate a type of the command 350a (e.g., read command, write command, etc.). The argument 355 may contain information and/or content of the command 350a. For example, the argument 355 may be filled with an address. The end bit 356 may indicate an end of the command 350a. Although it is not illustrated in FIG. 15A, the command 350a may further include a CRC code.

A controller 310a illustrated in FIG. 13 may determine whether the data to be written are the swap data based on the swap flag 343 included in the command 350a.

Referring to FIG. 15B, a command 350b may include a start bit 351, a transmission bit 352, a command index 354a, an argument 355 and an end bit 356. Although it is not illustrated in

FIG. 15B, the command 350b may further include a CRC code.

When a host transmits a write command, the host may fill the command index 354a with a swap data write command to inform a controller 310a illustrated in FIG. 13 that data to be written are swap data.

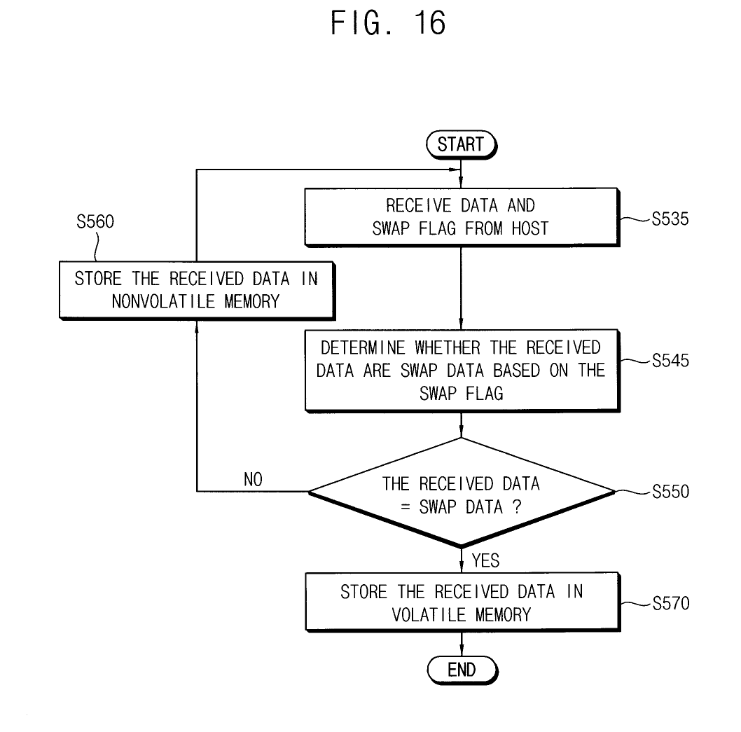

FIG. 16 is a flow chart illustrating a method of storing data in a storage device including a volatile memory device according to example embodiments.

Referring to FIGS. 13 and 16, a controller 310a may receive data and a swap flag indicating whether the received data are swap data from a host (S535). The controller 310a may determine whether the received data are the swap data based on the swap flag (S545).

If the received data are the normal data (S550: NO), the controller 310a may store the received data in the nonvolatile memory device 330 (S560). If the received data are the swap data (S550: YES), the controller 310a initially stores the received data in the volatile memory device 320 (S570). The swap data stored in the volatile memory device 320 may be output according to the method illustrated in FIG. 9.

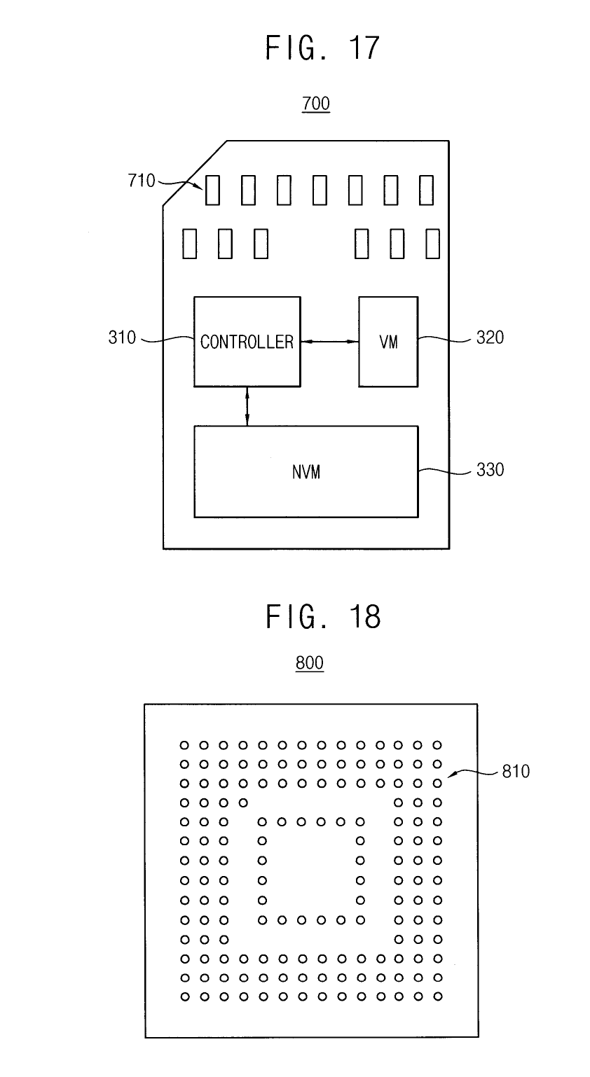

FIG. 17 is a diagram illustrating a memory card including a storage device according to example embodiments.

Referring to FIG. 17, a storage device 700 may include a plurality of connector pins 710, a controller 310, a volatile memory device 320 and a nonvolatile memory device 330.

The plurality of connector pins 710 may be coupled to a host to transmit and receive signals between the storage device 700 and the host. The plurality of connector pins 710 may include, for example, a clock pin, a command pin, a data pin and/or a reset pin.

The controller 310 may receive data from the host. The controller 310 may store the received data in the nonvolatile memory device 330 if the received data are normal data, and may store the received data in the volatile memory device 320 if the received data are swap data.

The storage device 700 may be a memory card, such as a multimedia card (MMC), a secure digital (SD) card, a micro-SD card, a memory stick, an ID card, a personal computer memory card international association (PCMCIA) card, a chip card, an USB card, a smart card, a compact flash (CF) card, etc.

In some embodiments, the storage device 700 may be coupled to a host, such as a mobile device, a mobile phone, a smart phone, a personal digital assistant (PDA), a portable multimedia player (PMP), a digital camera, a portable game console, a music player, a desktop computer, a notebook computer, a speaker, a video, a digital television, etc.

FIG. 18 is a diagram illustrating an embedded multimedia card including a storage device according to example embodiments.

Referring to FIG. 18, a storage device 800 may be an embedded multimedia card (eMMC) or a hybrid embedded multimedia card (hybrid eMMC). A plurality of balls 810 may be formed on one surface of the storage device 800. The plurality of balls 810 may be coupled to a system board of a host to transmit and receive signals between the storage device 800 and the host. The plurality of balls 810 may include, for example, a clock ball, a command ball, a data ball and/or a reset ball. According to certain embodiments, the plurality of balls 810 may be disposed at various locations. In one embodiment, the storage device 800, unlike a storage device 700 of FIG. 17 that is attachable and detachable to/from the host, may be mounted on the system board and such that it is not readily detachable from the system board by a user.

In some embodiments, the storage device 800 may be coupled to a host, such as a mobile device, a mobile phone, a smart phone, a PDA, a PMP, a digital camera, a portable game console, a music player, a desktop computer, a notebook computer, a speaker, a video, a digital television, etc.

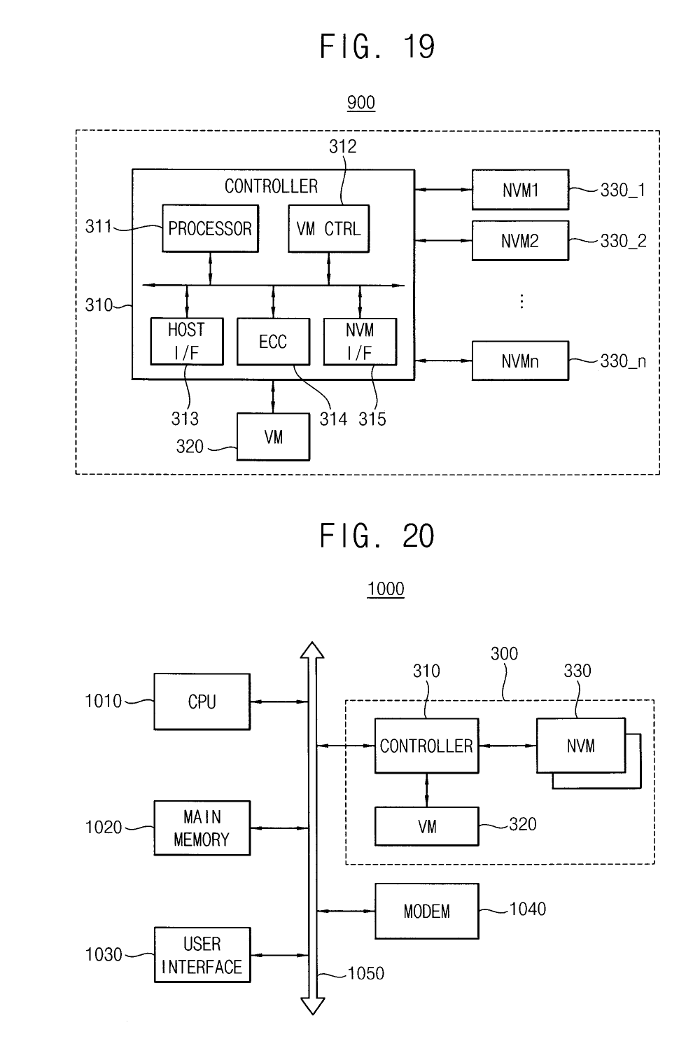

FIG. 19 is a diagram illustrating a solid state drive including a storage device according to example embodiments.

Referring to FIG. 19, a storage device 900 includes a controller 310, a volatile memory device 320 and a plurality of nonvolatile memory devices 330_1, 330_2 and 330_{—}n. In some embodiments, the storage device 900 is a solid state drive (SSD).

The controller 310 may include, for example, a processor 311, a volatile memory controller 312, a host interface 313, an error correction code (ECC) unit 314 and a nonvolatile memory interface 315. The processor 311 controls an operation of the volatile memory device 320 via the volatile memory controller 312. Although FIG. 19 illustrates an example where the controller 310 includes the separate volatile memory controller 312, in some embodiments, the volatile memory controller 312 may be included in the processor 311 or in the volatile memory device 320 (e.g., as part of the same chip or package). The processor 311 may communicate with a host via the host interface 313, and may communicate with the plurality of nonvolatile memory devices 330_1, 330_2 and 330_{—}n via the nonvolatile memory interface 315. The host interface 313 may be configured to communicate with the host using at least one of various interface protocols, such as a universal serial bus (USB) protocol, a multi-media card (MMC) protocol, a peripheral component interconnect-express (PCI-E) protocol, a serial-attached SCSI (SAS) protocol, a serial advanced technology attachment (SATA) protocol, a parallel advanced technology attachment (PATA) protocol, a small computer system interface (SCSI) protocol, an enhanced small disk Interface (ESDI) protocol, an integrated drive electronics (IDE) protocol, etc. Although FIG. 19 illustrates an example where the controller 310 communicates with the plurality of nonvolatile memory devices 330_1, 330_2 and 330_{—}n through a plurality of channels, in some embodiments, the controller 310 communicates with the plurality of nonvolatile memory devices 330_1, 330_2 and 330_{—}n through a single channel.

The ECC unit 314 may generate an error correction code based on data provided from the host, and the data and the error correction code may be stored in the plurality of nonvolatile memory devices 330_1, 330_2 and 330_{—}n. The ECC unit 314 may receive the error correction code from the plurality of nonvolatile memory devices 330_1, 330_2 and 330_{—}n, and may recover original data based on the error correction code. Accordingly, even if an error occurs during data transfer or data storage, the original data may be exactly recovered. According to certain embodiments, the controller 310 may be implemented with or without the ECC unit 314.

The controller 310 may receive data from the host. The controller 310 may store the received data in the plurality of nonvolatile memory devices 330_1, 330_2 and 330_{—}n if the received data are normal data, and may store the received data initially in the volatile memory device 320 if the received data are swap data.

In some embodiments, the storage device 900 may be coupled to a host, such as a mobile device, a mobile phone, a smart phone, a PDA, a PMP, a digital camera, a portable game console, a music player, a desktop computer, a notebook computer, a speaker, a video, a digital television, etc.

FIG. 20 is a block diagram illustrating a system including a hacking detecting device according to example embodiments.

Referring to FIG. 20, a mobile system 1000 includes a processor 1010, a main memory 1020, a user interface 1030, a modem 1040, such as a baseband chipset, and a storage device 300.

The processor 1010 performs various computing functions, such as executing specific software for performing specific calculations or tasks. For example, the processor 1010 may be a microprocessor, a central process unit (CPU), a digital signal processor, or the like. The processor 1010 may be coupled to the main memory 1020 via a bus 1050, such as an address bus, a control bus and/or a data bus. For example, the main memory 1020 may be implemented by a DRAM, a mobile DRAM, a SRAM, a PRAM, a FRAM, a RRAM, a MRAM and/or a flash memory. Further, the processor 1010 may be coupled to an extension bus, such as a peripheral component interconnect (PCI) bus, and may control the user interface 1030 including at least one input device, such as a keyboard, a mouse, a touch screen, etc., and at least one output device, a printer, a display device, etc. The modem 1040 may perform wired or wireless communication with an external device. The nonvolatile memory device 330 may be controlled by a controller 310 to store data processed by the processor 1010 or data received via the modem 1040. In some embodiments, the mobile system 1000 may further include a power supply, an application chipset, a camera image processor (CIS), etc.

The controller 310 may store normal data in the nonvolatile memory device 330, and may store swap data initially in a volatile memory device 320. Accordingly, a swap-out operation that stores the swap data from the main memory 1020 to the storage device 300 and a swap-in operation that stores the swap data from the storage device 300 to the main memory 1020 may be rapidly performed. Further, the performance of the mobile system 1000 may be improved.

In some embodiments, the storage device 300 and/or components of the storage device 300 may be packaged in various forms, such as package on package (PoP), ball grid arrays (BGAs), chip scale packages (CSPs), plastic leaded chip carrier (PLCC), plastic dual in-line package (PDIP), die in waffle pack, die in wafer form, chip on board (COB), ceramic dual in-line package (CERDIP), plastic metric quad flat pack (MQFP), thin quad flat pack (TQFP), small outline IC (SOIC), shrink small outline package (SSOP), thin small outline package (TSOP), system in package (SIP), multi chip package (MCP), wafer-level fabricated package (WFP), or wafer-level processed stack package (WSP).

The disclosed embodiments may be applied to any storage device including a volatile memory device, such as a memory card, a solid state drive, an embedded multimedia card, a hybrid embedded multimedia card, a universal flash storage, a hybrid universal flash storage, etc.

The foregoing is illustrative of example embodiments and is not to be construed as limiting thereof. Although a few example embodiments have been described, those skilled in the art will readily appreciate that many modifications are possible in the example embodiments without materially departing from the novel teachings and advantages of the present disclosure. Accordingly, all such modifications are intended to be included within the scope of the present inventive concept as defined in the claims. Therefore, it is to be understood that the foregoing is illustrative of various example embodiments and is not to be construed as limited to the specific example embodiments disclosed, and that modifications to the disclosed example embodiments, as well as other example embodiments, are intended to be included within the scope of the appended claims.

What is claimed is:

1. A method of storing data in a storage device including a volatile memory device and a nonvolatile memory device, the method comprising:
generating a swap address table containing address information about swap data;
receiving the data from a host;
determining whether the received data are the swap data based on the address information stored in the swap address table; and
selectively storing the received data in the volatile memory device or in the nonvolatile memory device according to a result of the determination.

2. The method of claim 1, wherein generating the swap address table comprises:
reading an address of a swap partition from a partition table stored in the nonvolatile memory device; and
generating the swap address table based on the read address of the swap partition.

3. The method of claim 1, wherein generating the swap address table comprises:
reading an address of a swap file stored in the nonvolatile memory device; and
generating the swap address table based on the read address of the swap file.

4. The method of claim 3, wherein the reading the address of the swap file comprises:
reading a start address of the swap file from a directory table stored in the nonvolatile memory device; and
reading addresses linked to the start address of the swap file from a file allocation table stored in the nonvolatile memory device.

5. The method of claim 1, wherein determining whether the received data are the swap data comprises:
determining whether an address of the received data exists in the swap address table.

6. The method of claim 1, wherein determining whether the received data are the swap data comprises:
translating a logical address of the received data into a physical address; and
determining whether the physical address exists in the swap address table.

7. The method of claim 1, wherein selectively storing the received data in the volatile memory device or in the nonvolatile memory device comprises:
if the received data are not the swap data, storing the received data in the nonvolatile memory device; and
if the received data are the swap data, storing the received data in the volatile memory device.

8. The method of claim 7, wherein storing the received data in the nonvolatile memory device comprises:
storing the received data using the volatile memory device as a buffer memory.

9. The method of claim 7, further comprising:
receiving a read request for the swap data from the host; and
providing the swap data stored in the volatile memory device to the host in response to the read request.

10. The method of claim 7, further comprising:
performing a delayed write operation that writes the swap data stored in the volatile memory device to the nonvolatile memory device while the storage device performs neither a write operation nor a read operation.

11. The method of claim 10, further comprising:
receiving a read request for the swap data from the host;
providing the swap data stored in the volatile memory device to the host in response to the read request; and
erasing the swap data that are stored in the nonvolatile memory device by the delayed write operation.

12. The method of claim 10, further comprising:
receiving other data to be stored in the volatile memory device;
if an unused region of the volatile memory device is not enough to store the other data, writing the other data to a region of the volatile memory device where the swap data are stored, thereby overwriting the swap data;
receiving a read request for the swap data from the host; and
providing the swap data that are stored in the nonvolatile memory device by the delayed write operation to the host in response to the read request.

13. A method of storing data in a storage device including a volatile memory device and a nonvolatile memory device, the method comprising:
receiving data and information indicating whether the received data is swap data or non-swap data from a host;
determining whether the received data are swap data or non-swap data based on the information; and
selectively storing the received data in the volatile memory device or in the nonvolatile memory device according to a result of the determination.

14. The method of claim 13, wherein the information is an address sent with the data.

15. The method of claim 13, wherein the information is a swap flag.

16. The method of claim 15, wherein the swap flag is included in a write command received from the host.

17. The method of claim 15, wherein the swap flag is appended to the data.

18. A storage device, comprising:
a volatile memory;
a nonvolatile memory; and
a controller configured to:
receive data from a host, the data being either swap data or non-swap data;
determine whether the data is swap data or non-swap data;
store the data in the volatile memory if the data is determined to be swap data; and
store the data in the nonvolatile memory if the data is determined to be non-swap data.

19. The storage device of claim 18, wherein the controller is further configured to:
perform a delayed write operation that writes swap data stored in the volatile memory to the nonvolatile memory during idle time;
overwrite the swap data stored in the volatile memory with second swap data received from the host; and
supply the swap data stored in the nonvolatile memory back to the host in response to a read request.

20. The storage device of claim 18, wherein the controller is further configured to:
determine whether the data is swap data or non-swap data based on either an address associated with the data or a swap flag associated with the data, such that if an address associated with the data is determined to be an address for swap data or if the swap flag indicates that the data is swap data, the data is stored in the volatile memory.
